(19) United States
(12) Patent Application Publication
(10) Pub. No.: US 2026/0181415 A1
(43) Pub. Date: Jun. 25, 2026

(54) METHODS, ARCHITECTURES, APPARATUSES AND SYSTEMS FOR DYNAMIC PROTOCOL DATA UNIT TRANSMISSION AND RETRANSMISSION MODE CONFIGURATION

(71) Applicant: InterDigital Patent Holdings, Inc., Wilmington, DE (US)

(72) Inventors: Senay Negusse, Montreal (CA); Tejaswinee Lutchoomun, Montreal (CA); Francois Periard, Montreal (CA); Tuong Hoang, Montreal (CA); Jaya Rao, Montreal (CA); Faris Alfarhan, Montreal (CA)

(21) Appl. No.: 18/989,564

(22) Filed: Dec. 20, 2024

(51) Int. Cl. H04W 24/02; H04L 5/00; H04W 88/06

(52) U.S. Cl. CPC H04W 24/02; H04L 5/0053; H04W 88/06

(57) ABSTRACT

Procedures, methods, architectures, apparatuses, systems, devices, and computer program products for transmitting one or more PDUs by a WTRU that includes an application layer (AL) and processing circuitry. The method includes receiving at least one PDU from the AL and for each PDU, determining respective characteristic information and selecting a transmission mode configuration from a set of transmission mode configurations based on the respective characteristic information. The method further includes transmitting each of the at least one PDU to a wireless network based on the respective selected transmission mode configuration.

### BACKGROUND

The present disclosure is generally directed to the fields of communications, software and encoding, including, for example, to methods, architectures, apparatuses, systems related to transmitting one or more protocol data units (PDUs) over a wireless network.

### SUMMARY

In certain representative embodiments, a method or procedure, and related apparatuses for selecting transmission mode configurations for data units (e.g., PDUs) is provided, enabling the apparatus to dynamically select and adapt the transmission mode as requirements for the transmission or re-transmission of individual PDUs dynamically change. Certain examples of data transmission and re-transmission modes (e.g., Radio Link Control Acknowledgement Mode (RLC AM) for Legacy Layer 2 (L2) data), which are configured for ensuring reliable delivery of PDUs may introduce significant latency overhead such that PDUs or PDU sets with low latency requirements may not be able to meet their respective delay deadlines. Additionally, data (e.g., L2 data) transmission and re-transmission modes, including feedback mechanisms, are based on static configurations which may not consider (e.g., inherent) structured and/or redundant information embedded on the application layer (AL) structured PDUs.

Procedures, methods, and apparatuses for transmitting one or more PDUs by a wireless transmit/receive unit (WTRU) that includes an AL and processing circuitry are provided herein. The methods include receiving PDUs from the AL and for each PDU, determining respective characteristic information and selecting a transmission mode configuration from a set of transmission mode configurations based on the respective characteristic information. The method further includes transmitting each of the at least one PDU to a wireless network based on the respective selected transmission mode configuration.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example WTRU that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a flowchart of an illustrative process for transmitting PDUs on a wireless network, which may be implemented using the communications system illustrated in FIG. 1A; and

FIG. 3 is a flowchart of another illustrative process for transmitting PDUs on a wireless network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

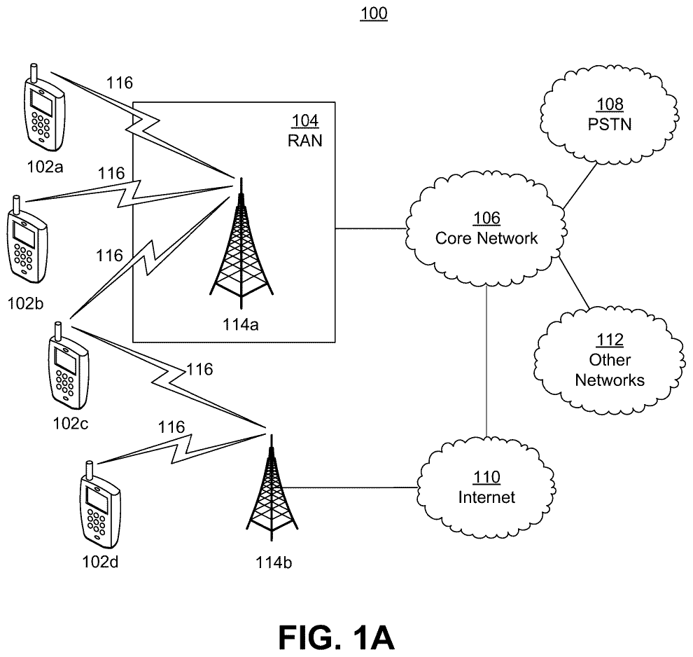

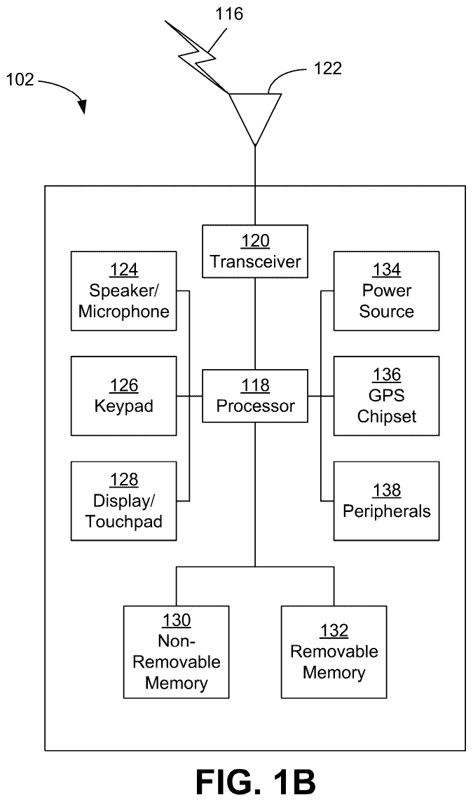

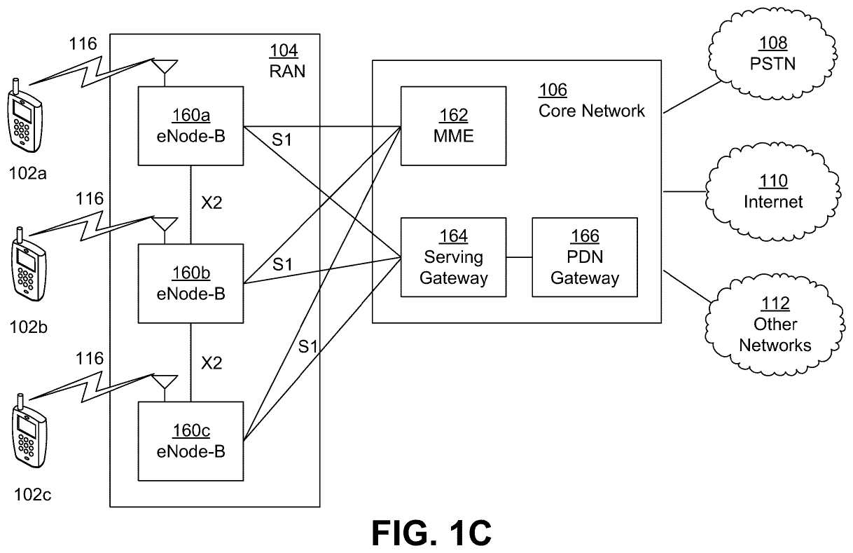

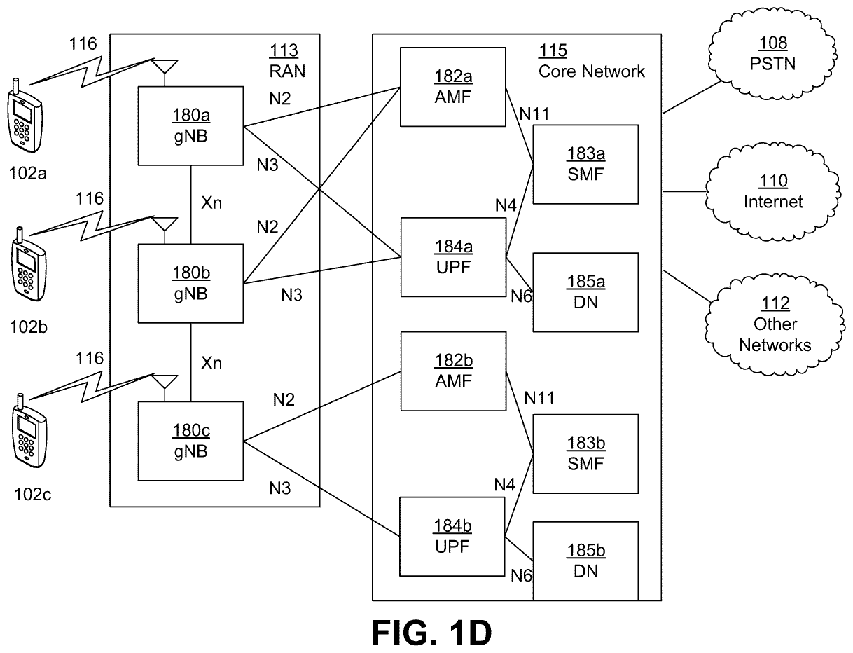

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a UE, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an evolved Node-B (eNB), a Home Node-B (HNB), a Home eNode-B (HeNB), a next generation Node-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation (CA) technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management (MM), and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

### Introduction of Extended Reality (XR)

The term eXtended reality (XR) is an umbrella term for different types of immersive experiences including VR, augmented reality (AR), mixed reality (MR), and any other suitable realities interpolated from them. VR may be defined as a rendered version of a visual and audio scene delivered to a user. In some embodiments, the rendering is designed to emulate visual (e.g. stereoscopic, three-dimensional (3D)) and audio sensory stimuli of the real world (e.g., as naturally as possible) to an observer or user as they move within the limits defined by the application. AR may be defined by an example embodiment, where a user is provided with additional information or (e.g., artificially) generated objects/items, or content overlaid upon their current environment. MR may be defined as an advanced form of AR where some virtual elements are inserted into the physical scene with the intent to provide the illusion that these elements are part of the real scene. In some embodiments, XR may include all real-and-virtual combined environments and human-machine interactions generated by user devices (e.g., computer technology and/or wearables). Immersion in the context of XR applications and services refers to a user's sense of being surrounded by the virtual environment as well as providing the user with a sense of physical and spatial location within the virtual environment. In some implementations of XE, levels of virtuality may range from partial sensory inputs to fully immersive multi-sensory inputs leading to VR that is (e.g., practically) indiscernible from actual reality.

In XR services and applications, the traffic may include one or more PDUs or data which may be associated with (1) an application data unit (ADU), (2) PDU set or (3) data burst. For example, PDUs associated with a PDU set may correspond to different segments or components of a video frame or a video slice. In some embodiments, a data burst may include one or more PDU sets that may be transmitted or received over a time window. For example, a number of PDUs included in a PDU set or data burst transmitted in UL and/or received in downlink may depend on a type of the media frame (e.g. 3D video frame, audio frame).

In some XR applications, the WTRU transmits XR traffic including one or more PDUs and/or PDU sets in UL (e.g., pose data, gesture data, video data) and/or receives XR traffic including one or more PDUs and/or PDU sets in DL (video data, audio data, haptic data). In some embodiments, such XR traffic (e.g., PDUs and/or PDU sets) may be transmitted and/or received periodically or aperiodically in one or more data flows (e.g. QoS flows). During UL transmissions, XR traffic (e.g., PDUs and/or PDU sets) may arrive from an application layer (AL) of the WTRU. In some embodiments, PDUs and/or PDU sets may arrive from other devices, terminals, or WTRUs (e.g., via sidelink, WiFi, or wired connection) at different instances of time. In some embodiments, XR traffic (e.g., PDUs and/or PDU sets) may be characterized by different attributes such as (1) variable payload sizes per PDU set, (2) a variable number of PDUs per PDU set, (3) a variable priority (e.g., importance level) per-PDU/PDU set, and (4) interdependencies between PDUs/PDUs sets. In some embodiments, the XR traffic (e.g. PDU/PDU sets) received by the WTRU may also experience different delays, jitter, data rate and loss rate. Therefore, data transmission/reception and other associated functions (e.g. prioritization, multiplexing, scheduling) are to be performed on a timely basis with XR awareness (e.g. awareness of PDU set attributes) to ensure a certain QoS and high user experience (e.g., quality of experience (QoE)).

### Application Layer Structured Data

A WTRU that supports applications and/or services (e.g., XR applications and/or services) may receive data units (e.g. PDUs, PDU sets or data bursts) from the wireless network or other devices (e.g. AR glasses, haptic gloves). In some embodiments, data units may be structured by the AL into one or more AL-structured data sets, such as PDUs or PDU sets. Information indicative of the inherent structure embedded in the AL-structured data (e.g., PDUs, PDU sets) may be accessed by lower network layers (e.g., L2), as the different encoding schemes (e.g., compression, AL forward error correction, network coding) used when generating data units (e.g., PDUs) are visible and distinguishable at lower network layers. For example, AL-structured data sets (e.g., PDUs and PDU sets) may be used for forward error correction (FEC), where at least a subset of the data units (e.g., PDUs) of a data set (e.g., PDU set) may be coded or structured to enable error correction and recovery of data. In some embodiments, the AL-structured data sets (e.g., PDUs and PDU sets) are used to enable error correction and recovery of data when some of the data units (e.g., PDUs) are received in error or lost at the receiving entity. In other embodiments, the AL-structured data sets (e.g., PDUs, PDU sets) may include enhancement data units (e.g., enhancement PDUs) that may be delivered to improve resolution and QoE. In some embodiments, the enhancement data units (e.g., enhancement PDUs) may be delivered if there is additional capacity and no congestion at the RAN. In such embodiments, when there is no additional capacity and/or congestion at the RAN, the enhancement data units (e.g., enhancement PDUs) may be discarded.

In some embodiments, the inherent embedded structure of AL-structured data (e.g., PDUs/PDU sets) may dictate the characteristic information of the PDUs/PDU sets and may define the requirements for acceptable QoE expected by the AL at the receiving entity. In sixth-generation (6G) wireless networks, various degrees of information regarding the AL-structured data (e.g., PDUs or PDU sets) may be acquired by lower layers (e.g., L2) to adapt and optimize the network performance. For example, information regarding the AL-structured data (e.g., PDUs or PDU sets) may be acquired for the optimization of physical (PHY) layer operations in layer 1 (L1) or RLC operations in L2.

### Radio Link Control

In NR, a transmission mode of L2 data (e.g., PDUs or PDU sets) may be statically configured by Radio Resource Control (RRC) based on a QoS assignment and/or radio bearer (RB) assigned to the L2 data. In some embodiments of NR, L2 data transmission mode is determined by the RLC. In some embodiments of NR, RLC operations may be essential to guarantee reliable delivery of PDUs generated from applications or services with strict reliability requirements, such as XR applications or services. NR RLC protocol may serve various operations including transferring of upper layer PDUs in one of three modes: (1) Acknowledged Mode (AM), Unacknowledged Mode (UM) and Transparent Mode (TM). In some embodiments, NR RLC protocol may serve other operations such as: (1) segmentation and reassembly of RLC service data units (SDUs), (2) duplicate detection, (3) RLC re-establishment, (4) protocol error detection and a few other tasks. A single RLC entity may perform both transmission and reception when in AM. In some embodiments, separate entities are used for transmission and reception while in TM and UM. Moreover, (e.g., only) data units (e.g., PDUs or PDU sets) are handled when in TM and UM. In some embodiments, both data and control PDUs are supported and handled while in AM. RLC operation in AM may offer reliable retransmissions (e.g., via Automatic Repeat reQuest, ARQ).

### Common Components

Throughout the embodiments described herein, the wireless network may include any one or more of a base station (e.g. gNB, transmission/reception point (TRP), RAN node, access node), core network function (e.g. AMF, SMF, policy control function (PCF), network exposure function (NEF)) and application function (e.g. edge server function, remote server function).

Throughout the embodiments described herein, a WTRU may correspond to any device or node which may come in a variety of form factors. A (e.g., typical) XR WTRU may include, but is not limited to, the following: (1) HMDs, (2) optical see-through glasses for AR and MR, (3) camera see-through HMDs for AR and MR, (4) mobile devices with positional tracking and camera, (5) wearables, (6) haptic gloves, (7) haptic body suit, or (8) haptic shoes. In addition to the above, several types of XR WTRUs may perform one or more XR device functions such as display, camera, sensors, sensor processing, wireless connectivity, XR or media processing and power supply. In some embodiments, one or more of the XR device functions may be provided by one or more devices, wearables, actuators, controllers and/or accessories. One or more device, node, or WTRU may be grouped into a collaborative XR group for supporting any XR application, experience, or service.

Throughout the embodiments disclosed herein, data flows may correspond to any QoS flows or data flows (e.g. flow of data including one or more PDUs, PDU sets or data bursts). In some embodiments, one or more PDU, PDU set, or data burst may be interdependent with another PDU, PDU set or data burst and/or associated with one or more QoS requirements, such as latency, data rate, reliability, or round-trip time (RTT) latency. In some embodiments, different flows, (e.g., possibly) originating from a common application or experience source and/or intended to a common destination device (e.g., WTRU) or group of associated devices (e.g., WTRU) may be referred to as associated flows or correlated flows.

Throughout the embodiments disclosed herein, a data unit may refer to any of one or more frames (e.g. media frame, video frame, audio frame, a slice, or segment), PDUs, PDU sets, data bursts, bitstreams, or a group of frames, PDUs, PDU-sets, and/or data bursts. In some embodiments, such data units, which may be transmitted or received by the WTRU sequentially (e.g. one after the other) or in parallel (e.g. over different channels, links, and/or resources), may not be interdependent with each other.

A PDU set may include one or more data units (e.g. PDUs) associated with a media unit, a video frame, or video slice. In some embodiments, the data units (e.g., PDUs) within a PDU set or data burst may be interdependent with other data units (e.g., other PDUs) within the PDU set at the AL and/or lower layers (e.g. AS-layers).

The attributes or properties of a PDU set may be differ from the attributes of other PDU sets in terms of, for example, the number of PDUs in each PDU set, payload sizes of the PDUs, intra-PDU set correlation, importance or priority of the PDUs, status of transmission (e.g. percentage of PDUs of one or more PDUs transmitted/received successfully), and effective data rate and/or effective reliability associated with transmission of the PDUs.

For example, such attributes associated with PDU sets may be visible at one or more lower network layer (e.g. at packet data convergence protocol (PDCP), RLC, MAC, PHY layers). In some embodiments, the attributes associated with the PDU sets are visible at one or more lower network layer to support additional actions (e.g. prioritizing, mapping to a logical channel (LCH), multiplexing to one or more transport blocks (TBs), or scheduling) based on one or more of the following: (1) markings in the data units (e.g., PDUs), (2) reception of an indication such as a control PDU, (3) mapping of the data units (e.g., PDUs) from a higher network layer to a configuration associated with a lower network layer, (4) tracking of the attributes of the PDUs at a buffer associated with a sublayer, RB, logical channel, or hybrid automatic repeat request (HARQ) processes, and (5) restrictions associated with the sublayer, RB, logical channel and/or HARQ process to which the data units (e.g., PDUs) of the PDU sets may be mapped.

For example, markings in the data units (e.g., PDUs) may include sequence numbers (SNs), IDs, indexes, timestamps, and time offset values (e.g. with respect to a reference time) in the header of the data units (e.g., PDUs). In some embodiments, the markings may be generated by higher network layers, any preceding sub-layer or layer, or any suitable device (e.g., another WTRU).

In some embodiments, the WTRU may receive an indication (e.g., a control PDU) such as an application layer, NAS layer, or any other suitable higher network layer indication, PDCP control PDU, RLC control PDU, MAC CE, Downlink Control Information (DCI) or uplink control information (UCI). Such an indication may be received by the WTRU from a higher network layer, preceding network layer, another WTRU (e.g. over SL) or wireless network.

In some embodiments, the WTRU may have visibility of one or more higher network layer attribute at a lower network layer when mapping the PDUs to one or more RBs, LCHs, TBs or HARQ processes that may be configured to provide similar forwarding capabilities.

In some embodiments, the WTRU may track the attributes associated with a PDU set based on one or more of: (1) the time elapsed since the reception of a first PDU of a PDU set, (2) the remaining time for the PDUs of a PDU set to satisfy the PDU Set Delay Budget (PSDB), (3) jitter between the arrival of one or more PDUs with the PDU set and/or across PDU sets, and (4) a percentage or payload size of remaining PDUs of a PDU set expected to be received.

In some embodiments, the WTRU may have visibility of the data units (e.g., PDUs) and determine corresponding actions (e.g. perform prioritization per logical channel prioritization (LCP), perform mapping to restricted configured grant (CG) configurations, TBs, or perform heuristic packet inspections (HPIs)) based on the configured restrictions associated with the one or more network sublayers, RBs and/or LCHs to which the data units (e.g., PDUs) may be mapped.

A data burst may refer to the data produced by an application (e.g., XR application) in a short period of time, including PDUs from one or more PDU sets. In some embodiments, attributes, associations and interdependencies (e.g. intra-PDU set dependencies and/or inter-PDU set dependencies), including (1) a start indication or end indication of a PDU set or data burst (e.g. via SN, start/end indication, timestamp), (2) a start time or end time, (3) duration, (4) payload sizes, (5) periodicity, (6) importance or priority, and (7) QoS (e.g. PSDB) may be visible to the AS-layers (e.g. with associated IDs) and/or handled at the AS layers with an awareness of the association during data (e.g., PDU) transmission in UL and reception in DL.

Different PDUs in a PDU set or all PDUs in a PDU set may be associated with different levels of importance or priority values. An importance or priority value of a PDU may correspond to spatial importance or temporal importance. For example, spatial importance may correspond to a spatial position of the video frame whose data is carried by the PDU or PDU set, where PDUs and PDU sets carrying Field of View (FoV) spatial positions may be associated with higher spatial importance than non-FoV spatial positions. As another example, temporal importance may correspond to a time sequence of the video frame or application frame whose data is carried by the PDU or PDU set, where PDUs and PDU sets carrying base video frames such as I-frame may be associated with higher temporal importance than differential video frames such as P-frame/B-frame. Such importance values (e.g., spatial or temporal) may be visible to the AS layers during data transmission and reception.

The PDUs and PDU sets of an application (e.g., XR application) may be encoded and delivered by the application to the WTRU (e.g., in UL) or wireless network (e.g., in DL) using one or more QoS flows or data flows. In some embodiments, different QoS flows carrying the PDUs or PDU sets associated to an application (e.g., XR application) or experience may be visible to the AS-layers and/or handled at the AS layers with an awareness of such association during data (e.g., PDU) transmission and reception.

Throughout the embodiments disclosed herein, the definition of a PDU set profile may include traffic characteristic information and PDU set-level QoS requirements referring to any of the following: (1) PSDB, (2) PDU Set Integrated Handling Indication (PSIHI), (3) PDU Set Error Rate (PSER), (4) jitter, (5) remaining delay, (6) the volume of the PDU set (e.g., size of each PDU and/or number of PDUs in the PDU set), and (7) one or more parameters associated with the AL-structured data set.

The PSDB may be defined as the time between reception of a first PDU (e.g., at the UPF in DL, or at the WTRU in UL) and the successful delivery of the last PDU of a PDU Set (e.g., at the WTRU in DL, or at the UPF in UL). In some embodiments, PSDB is an optional characteristic, and when provided, the PSDB supersedes the packet delay budget (PDB). The PSIHI may indicate whether all PDUs of the PDU set are needed for the usage of PDU set by AL. The PSER may be defined as an upper bound for a rate of non-congestion related PDU set losses or errors between a RAN and the WTRU.

Jitter may refer to a variation with respect to an expected time instance during which one or more data units (e.g., PDUs) may be received or transmitted. In some embodiments, for a set of data units (e.g., PDU set) that may be expected to be periodically received at different time instances, jitter may refer to the variation with respect to the periodic time instances. For example, for a data unit (e.g., PDU) that may be received T₁ milliseconds (ms) in advance of or T₂ ms later than an expected time instance at time T, the jitter range is T₂−T₁. In some embodiments, jitter may refer to an instantaneous value or a statistical value (e.g., an average, a variance, a standard deviation, a maximum value, or a minimum value).

A remaining delay may refer to a time duration remaining to receive or transmit one or more PDUs of a PDU set before the PSDB. Remaining delay may also refer to the time to live (TTL) associated with a PDU set. In some embodiments, the volume of the PDU set may include one or more of the size of each PDU and the number of PDUs in the PDU set. In some embodiments, one or more parameters (e.g., Application Layer Forward Error Correction ratio (AL-FEC ratio) associated with AL-structured data set may be used to indicate a number of required PDUs to decode the PDU set.

In some embodiments, a data Set may be a PDU set, and the receiver (e.g., receiving entity) may need to successfully receive at least K number of PDUs out of N PDUs in the PDU set to (e.g., successfully) decode the PDU set (e.g., a video frame at AL). Herein, K or the ratio between K and N (i.e., K/N) may be used as one of the QoS parameters or QoE parameters for the PDU set to represent a redundancy parameter for the PDU set.

A data set may be a PDU set which may include multiple subsets within the PDU set. The WTRU may be required to successfully transmit a ratio or a certain number of PDUs of each subset of the PDU set to satisfy certain QoS or QoE requirements. The ratio of each PDU may be used as one or more QoS parameter or QoE parameter for the PDU set to represent the redundancy parameters for the PDU set.

Throughout the embodiments disclosed herein, the term “PDU” may be used to describe the PDU in any of a NAS layer, SDAP layer, PDCP layer, RLC layer, MAC layer, PHY layer, and/or any suitable network layer. Furthermore, the term “L2 PDU” may be used to describe a PDU which is being handled across the protocol stacks within L2 (e.g., SDAP, PDCP, RLC or any suitable, newly defined protocol stack within L2).

Throughout the embodiments disclosed herein, PDU transmission mode configuration and/or forwarding configurations may correspond to any of the following: (1) radio bearers, (2) LCHs, (3) logical channel groups (LCGs), (4) configuration parameters in the individual layers within the Access Stratum (AS) protocol stack, (5) parameters associated with LCP, and (6) radio resources. In some embodiments, RBs may include any one of a data radio bearer (DRB), a signaling radio bearer (SRB), a transport radio bearer, or a PDU set bearer. In some embodiments, the AS protocol stack includes one or more of service data adaptation protocol (SDAP), PDCP, RLC, MAC, PHY, or any other suitable protocol layers. In some embodiments, parameters associated with LCP may include priority, prioritized bit rate (PBR), bucket size duration (BSD), bandwidth parts (BWPs), carrier parameters, radio links or interfaces (e.g., links or side links). In some embodiments, radio resources may include a set of one or more frequency, time, and/or spatial resources such as symbols, slots, subcarriers, resource elements or beams. For example, radio resources may be associated with CGs, dynamic grants (DG) and/or any other suitable resource grants or grant free resources.

### Configurations Associated with Transmission Mode Selection

In some implementations, the WTRU may receive transmission mode configuration information and/or indications from the wireless network based on which the WTRU selects a transmission mode configuration (e.g., an L2 PDU transmission mode configuration) from a set of transmission mode configurations, where each transmission mode configuration corresponds to a transmission mode (e.g., an L2 PDU transmission mode). The transmission mode configuration information may include the set of transmission mode configurations corresponding to the available transmission modes (e.g., L2 PDU transmission modes) and a set of characteristic information of AL-structured data (e.g., PDUs or PDU sets). The indications received by the WTRU may include an indication of an association between (1) one or more characteristic of the AL-structured data and (2) one or more transmission mode configurations.

In some embodiments, the WTRU may receive the transmission mode configuration information and/or indications from the wireless network via one or more of: (1) RRC signals and/or messages, (2) control PDUs associated with any of the AS layers (e.g. SDAP control PDU, PDCP control PDU, RLC control PDU), (3) DL MAC Control Element (CE), (4) DCI, (5) Physical Downlink Shared Channel (PDSCH), and (6) NAS layer signaling.

In some embodiments, RRC signals or messages may be dedicated or unicast signals from any of SRBs, DRBs, or system information blocks (SIBs). For example, RRC messages may include RRC reconfiguration and/or RRC resume. Additionally, RRC signals may be used for configuring any parameters (e.g. AM, UM, and/or both) associated with transmission mode configurations (e.g., L2 PDU transmission mode configurations) for transmitting PDUs of a PDU set. RRC signals may be used for activating and/or deactivating any of the transmission mode configurations (e.g., L2 PDU transmission mode configurations). For example, the WTRU may be configured with N transmission mode configurations (e.g., L2 PDU transmission mode configurations) by default during RRC configuration such that one or more of the transmission mode configurations may be in use at a given time when handling one or more PDUs of a PDU set.

MAC CE may be used for receiving indications or transmission mode configuration information of the transmission mode configurations (e.g., L2 PDU transmission mode configurations), such as IDs or indexes of the transmission mode configurations, and/or characteristic information associated with each of the transmission mode configurations (e.g., L2 PDU transmission mode configurations).

The DCI (e.g. WTRU-specific DCI, group-common DCI, or cell-common DCI) may be used for receiving activation or deactivation indications for any of one or more transmission mode configurations (e.g., L2 PDU transmission mode configurations) and/or a subset of characteristic information associated with the transmission mode configurations (e.g., L2 PDU transmission mode configurations. Characteristic information associated with the transmission mode configuration may include the QoS required by the application, such as an AL-FEC ratio and/or a wireless network coding ratio. For example, L2 PDU transmission mode configurations may include AM with or without retransmission, UM with or without retransmission, and timing configuration for receiving feedback.

PDSCH may include any indications or transmission mode configuration information associated with transmission mode configurations (e.g., L2 PDU transmission mode configurations). In some embodiments, the indications or transmission mode configuration information may be received on a separate set of resources that may be encoded with data TB in a PDSCH transmission occasion (TO). In some embodiments, NAS layer signaling, such as a PDU Session Establishment Response or a PDU Session Modification Command, may be used to include the transmission mode configuration information and/or indications.

The transmission mode configuration information and/or indications related to the set of available transmission modes (e.g., L2 PDU transmission modes) may include one or more of (1) a set of transmission mode configuration information associated with the handling of a PDU at the transmitting and receiving entity (e.g., in L2), and (2) a set of characteristic information (e.g., QoS) associated with a PDU generated from an AL-structured data to one of the transmitting entities (e.g., L2 transmitting entities) and/or resources.

For example, the WTRU may transmit and/or retransmit a PDU with a transmission mode according to a corresponding transmission mode configuration, which solicits and/or instructs a corresponding receiving entity to provide information or feedback regarding the status of the received PDU. The feedback received by the WTRU may include an Acknowledgement (ACK) or Negative Acknowledgement (NACK) on the received success or failure of a respective PDU (e.g., in RLC AM, RLC Status PDU, PDCP status). The transmission mode configuration which solicits and/or instructs a corresponding receiving entity for feedback regarding the status of the PDU may include a number of parameters such as (1) a set of timers related to a duration of time the WTRU may wait before soliciting and/or requesting for feedback (e.g., t-PollRetransmit in RLC), and (2) a set of timers related to a duration of time a receiving entity of the PDU is expected to wait before sending a status report and/or feedback regarding the PDU (e.g., t-Reassembly, t-Status Prohibit in RLC, or t-Reordering in PDCP).

For example, the WTRU may transmit a PDU with a transmission mode according to a corresponding transmission mode configuration which does not require the corresponding receiving entity to provide information or feedback regarding the status of the received PDU. In some embodiments, the WTRU may transmit and/or retransmit a PDU according to a transmission mode configuration which may enable or disable re-transmission of the PDU. The transmission mode configuration for enabling/disabling re-transmission of a PDU may include one or more of the parameters such as: (1) an expiry of feedback timer, (2) feedback received from the receiving entity regarding the delivery status of a transmitted/retransmitted PDU, (3) a status of previously transmitted/retransmitted Dus which are associated with a current PDU, (4) an availability of resources, (5) a remaining time available in the PDB or PSDB, and (6) a maximum number of retransmissions.

For example, the WTRU may initiate retransmission of a PDU if a timer set at the beginning of the transmission and/or retransmission of the PDU has expired before receiving feedback (e.g., from a corresponding receiving entity). In some embodiments, the WTRU may initiate retransmission of a PDU if the WTRU received feedback indicating that a previous transmission and/or retransmission was unsuccessful. In some embodiments, the WTRU may initiate or terminate retransmission of a current PDU in response to whether the delivery of one or more previously transmitted or retransmitted PDUs, which are associated with the current PDU, has been unsuccessful or successful. For example, the WTRU may terminate retransmission of a current PDU in response to the delivery of one or more previously transmitted or retransmitted PDUs associated with the current PDU has been successful. In some embodiments, after receiving feedback (e.g., from a receiving entity), the WTRU may abandon retransmission of a PDU if available resources for retransmission are below a threshold resource value. In some embodiments, the WTRU may disable retransmission of a PDU after an initial transmission or retransmission, before receiving feedback, or after receiving feedback based on the remaining time available in the PDB or PSDB. Additionally, the WTRU may terminate retransmission of a PDU if a maximum number of retransmissions allowed for the PDU has been reached. In some embodiments, the WTRU may handle a PDU in accordance to a transmission mode configuration that allows the WTRU to re-segment PDUs.

The transmission mode configuration information may include a set of configuration information associated with mapping of characteristics (e.g., QoS) of a PDU generated from an AL-structured data to one of the transmitting entities (e.g., L2 transmitting entities) or resources. In some implementations, the WTRU may be configured to map characteristic information (e.g., QoS) of a PDU to a set of one or more transmission resources. Each of the transmission resources a respective PDU or PDU set is mapped to may include one or more of a data/signal radio bearer, a PDCP entity, or an RLC entity.

In some implementations, the WTRU may select a transmission mode configuration from the set of transmission mode configurations (e.g., L2 PDU transmission mode configurations) to employ when transmitting a PDU based on a set of configured rules and/or parameters associated with characteristic information of the AL-structured data from which the PDU is derived. The set of configured parameters associated with characteristic information of the AL-structured data may include one or more of the following: (1) PDU type, (2) PDU set type, (3) coding ratio, (4) dependencies between PDUs in PDU set, (5) PDB, (6) PDU Error Rate (PER), (7) size of PDU in the PDU set, and (8) PDUs relative priority.

For example, a PDU or PDU set may be assigned as one or more of the following types of PDUs: (a) a mandatory PDU, (b) a source PDU, (c) a repair PDU, (d) a redundant PDU, and (e) an enhancement PDU. A mandatory PDU may be defined as a PDU that is needed by the application, (e.g., for the successful decoding of a data unit). In some embodiments, each source PDU may be a mandatory PDU. In some embodiments, a repair PDU may be generated from a source PDU, and a repair PDU may be used to reconstruct or recover at least a source PDU. In some embodiments, redundant PDUs may be repair PDUs. In some embodiments, enhancement PDUs may be generated from a source PDU and/or repair PDU. For example, an enhancement PDU may be a packet needed for a higher quality usage of the PDU set by the AL. In some embodiments, an enhancement PDU may not be considered a mandatory PDU because the receiver may be able to determine or predict a missing enhancement PDU from another PDU (e.g., a source PDU). For example, a video frame delivered without any enhancement PDUs may still be considered as successfully delivered. In some embodiments, the PDU may be assigned a PDB value based on the AL-structured data and the PSDB. Additionally, the PDU may be assigned a PER value based on the AL-structured data and the PSER.

In some embodiments, the WTRU may be provided with an AL-FEC ratio and/or wireless network coding ratio, which may refer to the number of or percentage of PDUs in a PDU set that must be received without error for successful delivery of the PDU set to the AL at the receiving entity.

In some embodiments, different types of PDUs within the AL-structured data and/or PDU set may include various degrees of dependency with each other including one or more of the following dependencies: (1) dependencies between a source data unit (e.g., source PDU) and a repair data unit (e.g., source PDU) which may be characterized in any one of the following ways: (a) 1:1, (b) 1:1 but not every source packet may generate a repair packet, (c) 1:M, and (d) M:1, and (2) dependencies between a source data unit (e.g., source PDU), repair data unit (e.g., repair PDU), and enhancement data unit (e.g., enhancement PDU) which may be characterized in any one of the following ways: (a) 1:1, (b) 1:1 but not every source and/or repair packet may generate an enhancement packet, (c) 1:M, and (d) M:1.

Some examples of 1:1 dependencies may include that every source packet (e.g., source PDU) may generate a repair packet (e.g., repair PDU), and there may exist a direct dependency between a source packet (e.g., source PDU) and a repair packet (e.g., repair PDU) generated from the source packet (e.g., source PDU).

Some examples of 1:1 dependencies without every source packet (e.g., source PDU) may generate a repair packet (e.g., repair packet) may include that: (1) a source packet (e.g., source PDU) may generate a repair packet (e.g., repair PDU), (2) a repair packet (e.g., repair PDU) may be used to reconstruct the source packet (e.g., source PDU) from which it was generated, (3) a repair packet (e.g., repair PDU) may be used to reconstruct another source packet (e.g., source PDU) from which it was not generated, and (4) a source packet (e.g., source PDU) that is adjacent to the source packet (e.g., source PDU) from which it was generated.

Some examples of 1:M dependencies may include that: (1) a source packet (e.g., source PDU) may generate multiple repair packets (e.g., repair PDUs), (2) one or more repair packets (e.g., repair PDUs) may be used to reconstruct the source packet (e.g., source packet), and (3) multiple repair packets (e.g., repair PDUs) may be needed to reconstruct the source packet (e.g., source PDU).

Some examples of M:1 dependencies may include that several source packets (e.g., source PDUs) may be needed to generate a repair packet (e.g., repair PDU) and the repair packet (e.g., repair PDU) may be used to reconstruct any one or more of the source packets (e.g., source PDUs) used to generate the repair packet (e.g., repair PDU).

Dependencies between source, repair and enhancement data units (e.g., source, repair, and enhancement PDUs) may be characterized in any one of the following ways: (a) 1:1, (b) 1:1 but not every source and/or repair packet may generate an enhancement packet, (c) 1:M, and (d) M:1.

Some examples of 1:1 dependencies may include instances where every source packet (e.g., source PDU) and/or repair packet (e.g., repair PDU) may generate an enhancement packet (e.g., enhancement PDU) and there may exist a direct dependency between the source packet (e.g., source PDU) and/or repair packet (e.g., repair PDU) and the enhancement packet (e.g., enhancement PDU) generated from the source packet (e.g., source PDU) and/or repair packet (e.g., repair PDU).

Some examples of 1:1 dependencies without every source packet (e.g., source PDU) and/or repair packet (e.g., repair PDU) may generate an enhancement packet may include instances where (1) a source packet (e.g., source PDU) and/or repair packet (e.g., repair PDU) may generate an enhancement packet (e.g., enhancement PDU), (2) an enhancement packet (e.g., enhancement PDU) may be used to reconstruct the source packet (e.g., source packet) and/or repair packet (e.g., repair PDU) from which the enhancement packet (e.g., enhancement PDU) was generated, (3) an enhancement packet (e.g., enhancement PDU) may be used to reconstruct another source packet (e.g., source PDU) and/or repair packet (e.g., repair PDU) from which the enhancement packet (e.g., enhancement PDU) was not generated (e.g., a source packet (e.g., source PDU) and/or repair packet (e.g., repair PDU) that is adjacent to the source packet (e.g., source PDU) and/or repair packet (e.g., repair PDU) from which it was generated).

Some examples of 1: M dependencies may include instances where (1) a source packet (e.g., source PDU) and/or repair packet (e.g., repair PDU) may generate multiple enhancement packets (e.g., enhancement PDUs), (2) one or more enhancement packet (e.g., enhancement PDU) may be used to reconstruct the source packet (e.g., source PDU) and/or repair packet (e.g., repair PDU), and (3) multiple enhancement packets (e.g., enhancement PDUs) may be needed to reconstruct the source packet (e.g., source PDU) and/or repair packet (e.g., repair PDU).

Some examples of M:1 dependencies may include instances where several source packets (e.g., source PDUs) and/or repair packets (e.g., repair PDUs) may be needed to generate an enhancement packet (e.g., enhancement PDU), and the enhancement packet (e.g., enhancement PDU) may be used to reconstruct any one or more of the source packet (e.g., source PDU) and/or repair packets (e.g., repair PDUs) used to generate the enhancement packet (e.g., enhancement PDU).

PDUs in a PDU set may be assigned a (e.g., relative) priority and/or importance value by the AL based on the PDU type (e.g., PDUs which are needed to decode other associated PDUs may have greater priority than other PDUs).

The characteristic information associated with the AL-structured data may be visible to the application (e.g., XR application) in the WTRU. In some embodiments, the WTRU may be configured to determine the characteristic information associated with the AL-structured data by using application layer signaling, RRC signaling or NAS-layer signalizing.

### Methods to Determine Relevant PDU Related Parameters for Selecting Transmission Mode Configuration

In some implementations, the WTRU receives a PDU from the AL, determines characteristic information (e.g., the relevant parameters and/or characteristics) of the PDU, and selects a forward mode configuration (e.g., an L2 PDU forwarding mode configuration) based on the determined characteristic information. The WTRU may determine the characteristic information (e.g., relevant parameters and/or characteristics) of the PDU based on explicit parameters/IDs or implicit parameters/IDs that are detectable in the PDU set by the WTRU. In some embodiments, the detectable parameters/IDs used to determine the characteristic information (e.g., relevant parameters and/or characteristics) of the PDU may be configured in the WTRU (e.g. via RRC signaling, NAS-layer signalizing or AL signaling). In some embodiments, the parameters/IDs used by the WTRU for identifying the relevant PDU-related parameters for selecting a forwarding mode configuration (e.g., L2 PDU forwarding mode configuration) may include one or more of the following: (1) an identifier (ID) associated with application layer structured PDU set, (2) a threshold value associated with the coding ratio applied in the AL-structured data or PDU set, (3) a threshold value associated with a priority or importance value, (4) a threshold value associated with a size of the PDU, (5) a threshold value associated with the number of PDU in a PDU set, (6) a threshold value associated with the physical layer resource granted by the network, (7) a class and/or type of PDUs to which a PDU belongs, (8) a threshold value associated with the degree of dependency between PDUs in a PDU set, (9) a type of expected feedback associated with a PDU, and (10) a threshold value associated with the remaining time available in the PDB and/or PSDB.

In some embodiments, the WTRU may determine that a PDU is associated with a (e.g., relevant) AL-structured PDU set. For example, the WTRU may detect a common ID associated with an application within the PDUs (e.g. in the header and/or payload of the PDU). In some implementations, the ID of the application may be preconfigured in the WTRU.

In some implementations, the WTRU may determine a coding ratio (e.g., AL-FEC ratio or wireless network coding rate) of a PDU as a relevant parameter (i.e., as part of characteristic information) for selecting a forwarding mode configuration (e.g., an L2 PDU forwarding mode configuration). In such implementations, the WTRU selects the forwarding mode configuration based at least on the determined coding ratio (e.g., AL-FEC ratio or wireless network coding rate) value in the PDUs (e.g. in the header and/or payload of the PDUs). In some embodiments, the WTRU selects the forwarding mode configuration based on a comparison of the determined coding ratio value with a configured coding ratio threshold value.

In some implementations, the WTRU may determine a priority or importance level of a PDU as a parameter (i.e., as part of the characteristic information) for selecting a transmission mode configuration (e.g., an L2 PDU transmission mode configuration). In some embodiments, the WTRU selects the transmission mode configuration based on the determined priority or importance indications of the PDUs (e.g. in the header and/or payload of the PDUs). In some embodiments, the WTRU selects the transmission mode configuration based on a comparison of the determined priority or importance levels with a configured priority threshold value.

In some implementations, the WTRU may determine the size of the PDU as a parameter (i.e., as part of characteristic information) for selecting a transmission mode configuration (e.g., L2 PDU transmission mode configuration). In some embodiments, the WTRU selects the transmission mode configuration based on the determined size of the PDU. In some embodiments, the WTRU selects the transmission mode configuration based on a comparison of the determined PDU size with a configured PDU size threshold value.

In some implementations, the WTRU may determine the number of PDUs in a PDU set as a parameter (i.e., as part of characteristic information) for selecting a transmission mode configuration (e.g., L2 PDU transmission mode configuration). In some embodiments, the WTRU selects the transmission mode configuration based on the determination that the PDU belongs to a PDU set with a total number of PDUs which is above or below a configured PDU per PDU set threshold value.

In some implementations, the WTRU may determine the size of granted resources as parameter (i.e., as part of characteristic information) for selecting a transmission mode configuration (e.g., an L2 PDU transmission mode configuration). In some embodiments, the WTRU selects the transmission mode configuration based on the determination of the size of available physical layer resources for transmitting a PDU. In some embodiments, the WTRU selects the transmission mode configuration based on a comparison of the size of available physical layer resources for transmitting a PDU with a threshold granted physical layer resource value.

In some implementations, the WTRU may determine the type of PDU as a parameter (i.e., as a part of characteristic information) for selecting a transmission mode configuration (e.g., an L2 PDU transmission mode configuration). In some embodiments, the WTRU determines the type of PDU based on an indication included in the PDU (e.g. in the header and/or payload of the PDU) from the AL.

In some implementations, the WTRU may determine the dependency of a PDU with other PDUs in the PDU set as a parameter (i.e., as part of the characteristic information) for selecting a transmission mode configuration (e.g., an L2 PDU transmission mode configuration). In some embodiments, the WTRU selects the transmission mode configuration based on the degree of dependency (e.g., 1:1, 1:M, M:1) of PDUs across the PDU set. In some embodiments, the WTRU selects the transmission mode configuration based on a comparison of a degree of dependency with a threshold degree of dependency value.

In some implementations, the WTRU may determine the type of expected feedback as a parameter (i.e., as part of the characteristic information) for selecting a transmission mode configuration (e.g., L2 PDU transmission mode configuration). In some embodiments, the WTRU determines the type of expected feedback based on an indication in the PDU (e.g. in the header and/or payload of the PDU) from the AL and/or an explicit indication from the wireless network.

In some implementations, the WTRU may determine the remaining time available in the PDB and/or PSDB of PDUs in a PDU set as a parameter (i.e., as part of characteristic information) for selecting a transmission mode configuration (e.g., L2 PDU transmission mode configuration). In some embodiments, the WTRU selects the transmission mode configuration based on a comparison of the determined remaining time available in the PDB and/or PSDB with a configured threshold remaining time value.

### Methods for Selecting Transmission Mode Configuration

In some implementations, the WTRU selects a transmission mode configuration (e.g., L2 PDU transmission mode configuration) from a set of transmission mode configurations (e.g., set of L2 PDU transmission mode configurations) which is then applied when transmitting and/or retransmitting a PDU in a PDU set. The WTRU may select the transmission mode configuration (e.g., L2 PDU transmission mode configuration) based on the determined characteristic information (e.g., characteristics and/or parameter set) associated with the AL-structured data/PDU set.

In some implementations, after receiving the transmission mode configuration information and/or indications, a WTRU running an application (e.g., XR application) that generates AL-structured data (e.g., PDUs) may begin to receive PDUs from the AL and associated characteristic information of the PDU and/or the AL-structured data (e.g., PDU set) generating the PDU. In some embodiments, the WTRU may also receive, from lower layers (e.g., L2), an indication of the size of the resource granted for transmitting and/or retransmitting the PDU or the PDU set to which the PDU belongs.

In some implementations, the WTRU determines that the PDU belongs to a PDU set with N number of PDUs and the AL may indicate a minimum number of PDUs that must be successfully delivered to correctly decode the PDU set in the AL at the receiving entity.

For example, when WTRU determines that the AL at the receiver (e.g., receiving entity) can successfully receive the PDU set based on at least X number of correctly received PDUs out of N number of PDUs in the PDU set, then the WTRU may select one or more of the following transmission mode configurations (e.g., L2 PDU transmission mode configurations): (1) transmit Z_{AM} out of the N PDUs (2) transmit Z_{UM} out of the N PDUs, and (3) determine the number of PDUs, Z_{AM} and Z_{UM}, to transmit and/or retransmit.

Transmitting Z_{AM} out of the N PDUs according to a transmission mode configuration (e.g., L2 PDU transmission mode configuration) may solicit or indicate to the receiving entity to provide information regarding a status of the received PDU (e.g., RLC AM). The transmission mode configuration set (e.g., for L2 PDU transmission) of the Z_{AM} PDUs may include a transmission mode configuration that requires one or more of Z_{Ack} PDUs to be retransmitted. In some embodiments, the one or more Z_{Ack} PDUs are retransmitted based on the received feedback (e.g., NACK) or the expiry of a timer related to the receiving of feedback.

Transmitting Z_{UM} out of the N PDUs according to a transmission mode configuration (e.g., L2 PDU transmission mode configuration) may not require the receiving entity to provide information regarding the status of the received PDUs (e.g., RLC UM). The transmission mode configuration set (e.g., for L2 PDU transmission) of the Z_{UM} PDUs may include a transmission mode configuration that requires one or more of Z_{UM} PDUs to be retransmitted. In some embodiments, the one or more Z_{UM} PDUs are retransmitted based on the type of the PDUs, the relative priority, or importance value associated with the PDU.

In some embodiments, the WTRU may be configured to determine the number of PDUs, Z_{AM} and Z_{UM}, to transmit and/or retransmit in accordance to a transmission mode configuration (e.g., an L2 PDU transmission mode configuration) which may expect or may not expect feedback based on a set of rules or function of X number of correctly received PDUs (e.g., Z_{AM}=f₁(X), Z_{UM}=f₂(X)).

In some implementations, the WTRU may begin transmitting and/or retransmitting one or more PDUs with a default transmission mode configuration (e.g., an L2 PDU transmission mode configuration) and selects a new transmission mode configuration (e.g., L2 PDU transmission mode configuration) for transmitting and/or retransmitting PDUs based on one or more conditions.

For example, if the WTRU receives an ACK for a K number of PDUs out of an L number of previously transmitted PDUs using a default transmission mode configuration corresponding to a default transmission mode (e.g., a default L2 PDU transmission mode) where K is compared to a configured threshold for the number of received ACKs, the WTRU may then select a second transmission mode configuration (e.g., L2 PDU transmission mode configuration) for transmitting and/or retransmitting the remaining R (e.g., R=L−K) PDUs in the PDU set. In some embodiments, the second transmission mode configuration (e.g., L2 PDU transmission mode configuration) may correspond to a less conservative and/or less resource demanding transmission mode (e.g., L2 transmission mode), such as UM mode, which may be applied when the reliability requirement for PDUs is less strict.

The WTRU may select a new transmission mode configuration (e.g., an L2 PDU transmission mode configuration) for transmitting and/or retransmitting PDUs in response to the WTRU determining that the remaining time in the PDB and/or PSDB is below a threshold value. For example, when the WTRU determines that the remaining time is below a configured threshold associated with the PDB and/or PSDB, the WTRU may transmit and/or retransmit the remaining PDUs in the PDU set using a transmission mode configuration (e.g., an L2 PDU transmission mode configuration) that may not require feedback from the receiving entity and/or subsequent retransmissions.

In some implementations, the WTRU may determine that a degree of dependency between a PDU with all other PDUs in the PDU set is above a threshold value related to the association between PDUs in the PDU set. For example, a PDU may be a repair PDU with a 1:K dependency with source PDUs, indicating that any one or more of the K repair PDUs may be used to reconstruct one source PDU. In some embodiments, when K is greater than a threshold value M related to the degree of dependency of the repair PDU with other PDUs, WTRU may also determine to apply a transmission mode configuration (e.g., an L2 PDU transmission mode configuration) to transmit the PDU with a transmission configuration mode corresponding to a less conservative and/or less resource demanding transmission mode (e.g., L2 transmission mode), such as UM mode.

The WTRU may send an indication regarding a selected transmission mode configuration (e.g., L2 PDU transmission mode configuration) and/or a change in the transmission mode configuration (e.g., L2 PDU transmission mode configuration). For example, when the default transmission mode configuration is AM and the WTRU changes to UM for transmission and/or retransmission of subsequent PDUs, the WTRU may send the indication regarding the change in the transmission mode configuration. The WTRU may be configured to transmit the indication onto a wireless network or to a receiving entity at a gNB (e.g., in AS-layer signaling, MAC CE, or UCI). The indication may be indicative of the transmission mode configuration applied to a PDU or subset of PDUs or the change in default transmission mode configuration for transmitting the PDU or a subset of PDUs.

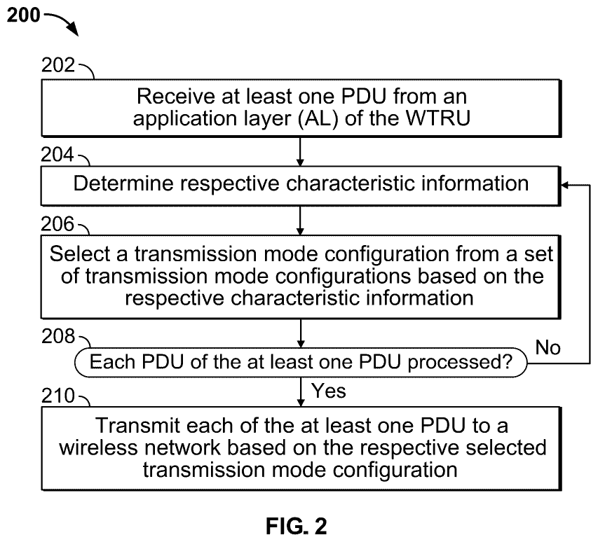

FIG. 2 shows a flowchart of an illustrative process 200 for transmitting PDUs on a wireless network, which may be implemented using the communications system illustrated in FIG. 1A.

At 202, the WTRU receives at least one PDU from an AL of the WTRU.

At 204, the WTRU determines respective characteristic information of a respective PDU of the PDUs received at 202. The characteristic information of the PDU that may be used for selecting the transmission mode configuration (e.g., L2 PDU transmission mode configuration), at 206, may include one or more of (1) association information across PDUs in the PDU set, (2) a type of PDUs, (3) priority or importance (e.g., a PDU belonging to keyframe (I-frame) may have a greater priority than a PDU belonging to a predicted frame (P-frame)), (4) available resources that may be granted for transmitting PDUs or PDU sets, or (5) feedback (e.g., L2 feedback) from a receiving entity, such as, an RLC status PDU.

At 206, the WTRU selects a transmission mode configuration from a set of transmission mode configurations based on the respective characteristic information determined at 204. The WTRU is configured to select a transmission mode configuration corresponding to a transmission mode (e.g., an L2 PDU transmission mode) that the WTRU is to apply to a PDU. In some embodiments, the characteristic information includes characteristics and/or requirements of AL-structured data or PDUs. The WTRU may be configured with a set of transmission mode configurations (e.g., a set of L2 PDU transmission mode configurations), such as RLC configurations. In some embodiments, each transmission mode configuration is associated to a set of AL PDU characteristics. One or more transmission mode configuration (e.g., L2 PDU transmission mode configuration), such as RLC AM, RLC TM, or RLC UM may be included in the set of transmission mode configurations from which the WTRU selects to apply to PDUs for transmission or re-transmission. In some embodiments, the WTRU may select the transmission mode configuration according to a set of rules associated with the characteristic information (e.g., AL-FEC ratio, priority, importance) of the AL-structured PDUs. In some embodiments, the set of rules map each transmission mode configuration of the set of transmission mode configurations to a respective set of characteristic information values. In such embodiments, the WTRU may select the transmission mode configuration from the set of transmission mode configurations by comparing the respective characteristic information of the PDUs to each respective set of characteristic information values. The WTRU may select the transmission mode configuration (e.g., L2 PDU transmission mode configuration) to apply to PDU transmission or re-transmission based on one or both of the received transmission mode configuration information and the determined characteristic information of a PDU or a subset of PDUs.

At 208, the process 200 determines whether each PDU of the at least one received PDU has been processed at steps 204 and 206. If each of the PDUs have not been processed, process 200 proceeds to 204 to determine respective characteristic information for a PDU of the received PDUs that have yet to be processed. Once each of the PDUs have been processed, process 200 proceeds to transmit each of the at least one PDU to a wireless network based on the respective selected transmission mode configuration, at 210.

At 210, the WTRU transmits each of the at least one PDU to a wireless network based on the respective selected transmission mode configuration.

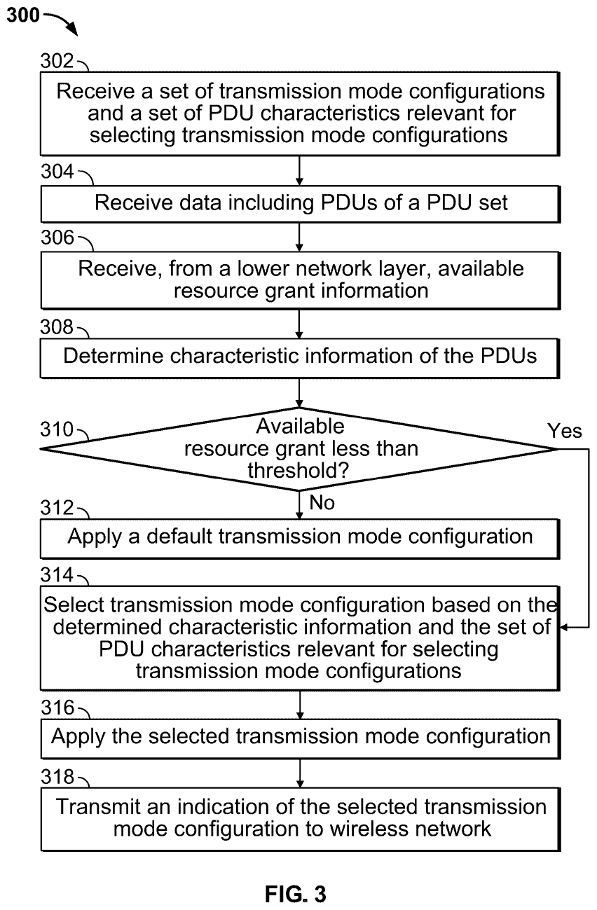

FIG. 3 shows a flowchart of an illustrative process 300 for transmitting PDUs on a wireless network, which may also be implemented using the communications system illustrated in FIG. 1A.

At 302, the WTRU receives a set of transmission mode configurations and a set of PDU characteristics relevant for selecting transmission mode configurations.

At 304, the WTRU receives data including PDUs of a PDU set.

At 306, the WTRU receives, from a lower network layer, available resource grant information.

At 308, the WTRU determines characteristic information of the PDUs.

At 310, process 300 determines whether the available resource grant is less than a threshold value based on the available resource grant information received at 306. If the available resource grant is equal to or greater than the threshold value, process 300 proceeds to 312 to apply a default transmission mode configuration. If the available resource grant is less than the threshold value, process 300 proceeds to select the transmission mode configuration based on the determined characteristic information and the set of PDU characteristics relevant for selecting transmission mode configurations, at 314.

At 314, the WTRU selects the transmission mode configuration based on the determined characteristic information and the set of PDU characteristics relevant for selecting transmission mode configurations.

At 316, the WTRU applies the selected transmission mode configuration.

At 318, the WTRU transmits an indication of the selected transmission mode configuration to wireless network.

Processes 200 and 300 enable the WTRU to dynamically select and adapt the transmission mode configuration (e.g., L2 PDU transmission mode configuration) as requirements for the transmission or re-transmission of individual PDUs or a subset of PDUs acquired from AL-structured data dynamically change. For example, the requirements for the transmission or re-transmission of PDUs may change according to changes in the application (e.g., XR application) and/or as a result of feedback received from a receiving entity.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a RF transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving at least one PDU from an application layer (AL) of the WTRU;
for each PDU of the at least one PDU:
determining respective characteristic information, and
selecting a transmission mode configuration from a set of transmission mode configurations based on the respective characteristic information; and
transmitting each of the at least one PDU to a wireless network based on the respective selected transmission mode configuration.

2. The method of claim 1, wherein, for each PDU of the at least one PDU, determining the respective characteristic information comprises determining whether the respective PDU is a redundant PDU of another PDU of the at least one PDU.

3. The method of claim 2, wherein for each PDU of the at least one PDU, selecting the transmission mode configuration from the set of transmission mode configurations comprises selecting a less resource-demanding transmission mode configuration based on the determining that the respective PDU is redundant to the other PDU.

4. The method of claim 1, the method further comprising:
for each of the at least one PDU, transmitting a respective indication to the wireless network, wherein each respective indication comprises information of the respective selected transmission mode configuration.

5. The method of claim 1, wherein the AL of the WTRU comprises one or more extended reality (XR) applications.

6. The method of claim 1, wherein receiving the at least one PDU comprises receiving at least one Layer 2 (L2) PDU.

7. The method of claim 1, wherein transmitting each of the at least one PDU to the wireless network comprises transmitting each of the at least one PDU to the wireless network without expectation of receiving a respective acknowledgement signal for each of the at least one PDU from the wireless network.

8. The method of claim 1, wherein the respective characteristic information comprises one or more of: (1) PDU type, (2) a coding ratio, (3) an interdependency with other PDUs of the at least one PDU, (4) PDU delay budget (PDB), (5) PDU error rate (PER), (6) PDU size, or (7) PDU priority, or a combination thereof.

9. The method of claim 1, wherein the set of transmission mode configurations comprises one or more of: (1) a radio link control (RLC) acknowledgement mode (AM) configuration, (2) an RLC transparent mode (TM) configuration, or (3) an RLC un-acknowledgement mode (UM) configuration, or a combination thereof.

10. The method of claim 1, wherein selecting the transmission mode configuration from the set of transmission mode configurations comprises selecting the transmission mode configuration from the set of transmission mode configurations according to a set of rules that map each transmission mode configuration of the set of transmission mode configurations with a respective set of characteristic information values, and wherein selecting the transmission mode configuration from the set of transmission mode configurations according to the set of rules comprises:
comparing the respective characteristic information to each respective set of characteristic information values, and
selecting the transmission mode configuration from the set of transmission mode configurations based on the comparing of the respective characteristic information to each respective set of characteristic information values.

11. A wireless transmit/receive unit (WTRU) comprising an application layer (AL) and processing circuitry, wherein the WTRU is to:
receive at least one PDU from the AL;
for each PDU of the at least one PDU:
determine respective characteristic information, and
select a transmission mode configuration from a set of transmission mode configurations based on the respective characteristic information; and
transmit each of the at least one PDU to a wireless network based on the respective selected transmission mode configuration.

12. The WTRU of claim 11, wherein, for each PDU of the at least one PDU, to determine the respective characteristic information the WTRU is to determine whether the respective PDU is a redundant PDU of another PDU of the at least one PDU.

13. The WTRU of claim 12, wherein for each PDU of the at least one PDU, to select the transmission mode configuration from the set of transmission mode configurations the WTRU is to select a less resource-demanding transmission mode configuration based on the determination that the respective PDU is redundant to the other PDU.

14. The WTRU of claim 11, wherein the WTRU is further to:
for each of the at least one PDU, transmit a respective indication to the wireless network, wherein each respective indication comprises information of the respective selected transmission mode configuration.

15. The WTRU of claim 11, wherein the AL comprises one or more extended reality (XR) applications.

16. The WTRU of claim 11, wherein to receive the at least one PDU the WTRU is to receive at least one Layer 2 (L2) PDU.

17. The WTRU of claim 11, wherein to transmit each of the at least one PDU to the wireless network the WTRU is to transmit each of the at least one PDU to the wireless network without expectation of receiving a respective acknowledgement signal for each of the at least one PDU from the wireless network.

18. The WTRU of claim 11, wherein the respective characteristic information comprises one or more of: (1) PDU type, (2) a coding ratio, (3) an interdependency with other PDUs of the at least one PDU, (4) PDU delay budget (PDB), (5) PDU error rate (PER), (6) PDU size, or (7) PDU priority, or a combination thereof.

19. The WTRU of claim 11, wherein the set of transmission mode configurations comprises one or more of: (1) a radio link control (RLC) acknowledgement mode (AM) configuration, (2) an RLC transparent mode (TM) configuration, or (3) an RLC un-acknowledgement mode (UM) configuration, or a combination thereof.

20. The WTRU of claim 11, wherein to select the transmission mode configuration from the set of transmission mode configurations the WTRU is to select the transmission mode configuration from the set of transmission mode configurations according to a set of rules that map each transmission mode configuration of the set of transmission mode configurations with a respective set of characteristic information values, and wherein to select the transmission mode configuration from the set of transmission mode configurations according to the set of rules the WTRU is to:
compare the respective characteristic information to each respective set of characteristic information values, and
select the transmission mode configuration from the set of transmission mode configurations based on the comparison of the respective characteristic information to each respective set of characteristic information values.
